(19) United States
(12) Patent Application Publication
(10) Pub. No.: US 2023/0217394 A1
(43) Pub. Date: Jul. 6, 2023

(54) APPARATUSES OF A RADIO COMMUNICATIONS NETWORK, METHODS TO OPERATE AN APPARATUS OF A COMMUNICATIONS NETWORK

(71) Applicant: Nokia Technologies Oy, Espoo (FI)

(72) Inventors: Frank FREDERIKSEN, Klarup (DK); Daniela LASELVA, Klarup (DK); Nuno Manuel KIILERICH PARTAS, Gistrup (DK)

(21) Appl. No.: 17/998,232

(22) PCT Filed: May 25, 2020
(86) PCT No.: PCT/EP2020/064353

§ 371 Date: Nov. 8, 2022

(51) Int. Cl. H04W 56/00

(52) U.S. Cl. CPC H04W 56/0045

(57) ABSTRACT

There is described a method to operate an apparatus of a radio communications network, the method comprising at least: receiving at least one validity period indicator, which indicates at least one validity period for a timing advance configuration of the apparatus, and at least one preamble indicator, which indicates a preamble configuration; transmitting, prior to an end of the validity period, at least one preamble in dependence on the preamble configuration; receiving a timing advance command in response to the transmitted preamble; and updating the timing advance configuration of the apparatus in dependence on the received timing advance command.

### FIELD OF THE INVENTION

Various example embodiments relate to enhancements for radio communications networks.

### BACKGROUND

Timing advance is used to control the uplink transmission timing of individual UEs.

### SUMMARY

A first aspect of the description is directed to an apparatus, for example a first radio device, of a radio communications network, for example a radio access network, comprising at least one processor, at least one memory including computer program code, and at least one communication module, the at least one memory and computer program code configured, with the at least one processor, and the at least one communication module, to cause the apparatus at least to: receive at least one validity period indicator, which indicates at least one validity period for a timing advance configuration of the apparatus, and at least one preamble indicator, which indicates a preamble configuration; transmit, prior to an end of the validity period, the at least one preamble in dependence on the preamble configuration; receive a timing advance command in response to the transmitted preamble; and update the timing advance configuration of the apparatus in dependence on the received timing advance command.

Advantageously, a contention-free PRACH request configuration is provided, where the access preamble is to be used for initiating a lean random-access procedure with the purpose of adjusting the timing advance, when the validity period is about to expire.

The provided lean timing advance keep-alive scheme allows to use a contention-free based SDT, when uplink user plane data appears in the buffer of the first device. This minimizes the latency for the end user, as it guarantees that the timing advance is valid.

Timing advance is used to control the uplink transmission timing of individual UEs. The enhancements enable the use of Short Data Transmissions efficiently for the UEs, which operate in the RRC inactive state. In particular, timing misalignments of uplink communication are avoided or reduced. For example, pre-configured PUSCH resource with a time guard band in order to cope with a UL transmission timing misalignment due to the UE's movement can be avoided. In addition, the gNB receiver can avoid extracting from the UE's PUSCH transmission, the information that allows it to cope with timing misalignments during the PUSCH decoding process.

According to an advantageous example, the preamble configuration comprises at least one of the following: a preamble format; a preamble sequence; at least one dedicated radio resource.

Advantageously, the preamble is configured to be active for the first device at a specific radio resource, in a particular time and frequency. That is, the preamble configuration provides a configuration of the at least one physical radio resource for transmitting the preamble in the uplink is provided.

According to an advantageous example, the apparatus is further configured to: transmit a plurality of preambles via at least a part of a plurality of dedicated radio resources, which are separated in time over at least one validity period.

There are multiple, for example equidistant, radio resources for the apparatus, for example the first radio device, to request an update of its timing advance configuration. Advantageously, the apparatus is able to request a new timing advance command depending on its needs. For example, an expected highly dynamic movement/acceleration in space of the apparatus may trigger the apparatus to transmit a preamble via at least one of the plurality of dedicated resources for requesting a new timing advance command.

According to an advantageous example, the apparatus is further configured to transmit a plurality of preambles via at least a part of a plurality of dedicated radio resources, which are time contiguous within the at least one validity period.

Therefore, a burst mode for transmitting preambles is provided. By reserving multiple CF PRACH preambles across multiple PRACH opportunities, then the apparatus will be able to perform power ramping if indicated. With the CF RACH preambles configured in this burst mode, the apparatus is allowed to perform multiple random access attempts on the dedicated radio resources in relative sequence such that the apparatus can perform power ramping to compensate for potential changes in the propagation environment.

According to an advantageous example, the apparatus is further configured to increase a transmission power for the transmission of the respective preamble at least once.

Advantageously, power ramping is provided. Whenever an apparatus, for example a UE, performs a RACH procedure where the apparatus is in RRC idle or inactive, the apparatus sometimes has to perform multiple PRACH preamble transmission attempts at least a part of with an increasing transmission power in comparison with the previous transmission attempt until the preamble is successfully received/detected by the gNB. This power ramping procedure is advantageous due to the apparatus being uncertain of which uplink power to use to reach the gNB when the apparatus is in RRC idle/inactive. An estimation error associated with open loop power control results in this uncertainty with regard to the indicated transmit power. The uncertainty is advantageously tackled with the provided power ramping.

According to an advantageous example of the apparatus, the preamble is contention-free.

The use of a contention-free preamble limited to dedicated time instances, in particular coinciding with periodic RNA update and/or TA keep-alive events, allows reducing the preamble capacity demand, while it avoids a potential delay from preamble contention. Therefore, the preambles, for example of PRACH, are assigned in a contention-free mode. The preamble is not contended by different UEs but is dedicated for a specific UE. The validity of the contention-free preamble is limited to certain time/frequency resources. This means that at different time/frequency resources, a single sequence of a preamble can be used by different UEs. This increases resource efficiency.

According to an advantageous example, the apparatus is further configured to transmit a user plane payload in dependence on the timing advance configuration of the apparatus.

Timing advance is used to control the uplink transmission timing of individual apparatuses, UEs. Timing advance helps to ensure the uplink transmissions from a plurality of UEs are synchronized when received by the base station. For example, the UE furthest from the base station indicates a larger timing advance to compensate for the larger propagation delay. Inter-symbol interference can be reduced if the uplink transmissions are received with a time spread, which is less than the duration of the cycling prefix.

Advantageously, by using a valid timing advance value/a valid timing advance configuration, the second apparatus, the gNB, will receive the uplink data in form of the user plane payload in a synchronized manner.

According to an advantageous example of the apparatus, the validity period indicator and/or the at least one preamble indicator are part of an RRC Release message.

Advantageously, the transmission of the validity period indicator and/or the preamble indicator is associated with an RRC Connection suspension of the apparatus.

According to an advantageous example of apparatus, the validity period indicator is associated with an RAN

Notification Area, RNA, configuration, in which the validity period is set equal to or is less than a periodic update period of the RNA configuration.

Advantageously, the RNA update, i.e. a periodic RNA update procedure, coincides with the keep-alive procedure for the timing advance.

According to a second aspect of the description, an apparatus, for example a second radio device, for a radio communications network is provided. The apparatus comprises at least one processor, at least one memory including computer program code, and at least one communication module, the at least one memory and computer program code configured, with the at least one processor, and the at least one communication module, to cause the apparatus at least to: transmit or receive at least one validity period indicator, which indicates at least one validity period for a timing advance configuration, and at least one preamble indicator, which indicates a preamble configuration; receive the at least one preamble in accordance with the preamble configuration; determine a timing advance command; transmit the determined timing advance command in response to the received preamble.

The second device, the gNB, configures the timing advance keep-alive configuration by the transmission of the validity period indicator and by the transmission of the preamble indicator.

According to an advantageous example, the preamble configuration comprises at least one of the following: a preamble format; a preamble sequence; at least one dedicated radio resource.

According to an advantageous example, the apparatus is further configured to: receive a plurality of preambles via at least a part of a plurality of dedicated radio resources, which are separated in time over at least one validity period.

According to an advantageous example, the apparatus is further configured to receive a plurality of preambles via at least a part of a plurality of dedicated radio resources, which are time contiguous within the at least one validity period.

According to an advantageous example of the apparatus, the preamble is contention-free.

According to an advantageous example, the apparatus is further configured to receive user plane payload in dependence on the timing advance configuration of a further apparatus, for example the first radio device.

According to an advantageous example of the apparatus, the validity period indicator and/or the at least one preamble indicator are part of an RRC Release message.

According to an advantageous example, the validity period indicator is associated with an RAN Notification Area, RNA, configuration, in which the validity period is set equal to or is less than a periodic update period of the RNA configuration.

According to an advantageous example, the apparatus is configured to: determine a mapping of the preamble configuration to an identity of a further apparatus, for example the first radio device.

Advantageously, the identity of the further apparatus, for example the first radio device, can be determined based on determining the at least one preamble property when receiving a preamble, for example via a random access channel.

According to an advantageous example, the determination of the timing advance command comprises determining, via the determined mapping, the identity of the further apparatus, for example the first radio device, in dependence on the dedicated radio resource, the preamble was received.

Advantageously, the prior determined mapping is used to map the radio resource comprising the preamble to the identity of the first device.

According to a third aspect of the description a method to operate an apparatus for a radio communications network is provided, the method comprising at least: receiving at least one validity period indicator, which indicates at least one validity period for a timing advance configuration of the apparatus, and at least one preamble indicator, which indicates a preamble configuration; transmitting the at least one preamble prior to an end of the validity period; receiving a timing advance command in response to the transmitted preamble; and updating the timing advance configuration of the apparatus in dependence on the received timing advance command.

According to an advantageous example, the preamble configuration comprises at least one of the following: a preamble format; a preamble sequence; at least one dedicated radio resource.

According to an advantageous example, the method comprises transmitting a plurality of preambles via at least a part of a plurality of dedicated radio resources, which are separated in time over at least one validity period.

According to an advantageous example, the method comprises transmitting a plurality of preambles via at least a part of a plurality of dedicated radio resources, which are time contiguous within the at least one validity period.

According to an advantageous example, the method comprises increasing a transmission power for the transmission of the respective preamble at least once.

According to an advantageous example, the preamble is contention-free.

According to an advantageous example, the method comprises transmitting user plane payload in dependence on the timing advance configuration of the apparatus.

According to an advantageous example, the validity period indicator and/or the at least one preamble indicator are part of an RRC Release message.

According to an advantageous example, the validity period indicator is associated with an RAN Notification Area, RNA, configuration, in which the validity period is set equal to or is less than a periodic update period of the RNA configuration.

According to a third aspect a method to operate an apparatus of a radio communications network is provided, the method comprising at least: transmitting or receiving at least one validity period indicator, which indicates at least one validity period for a timing advance configuration, and at least one preamble indicator, which indicates a preamble configuration; receiving the at least one preamble in accordance with the preamble configuration; determining a timing advance command; transmitting the determined timing advance command in response to the received preamble.

According to an advantageous example, the preamble configuration comprises at least one of the following: a preamble format; a preamble sequence; at least one dedicated radio resource.

According to an advantageous example, the method comprises receiving a plurality of preambles via at least a part of a plurality of dedicated radio resources, which are separated in time over at least one validity period.

According to an advantageous example, the method comprises receiving a plurality of preambles via at least a part of a plurality of dedicated radio resources, which are time contiguous within the at least one validity period.

According to an advantageous example, the preamble is contention-free.

According to an advantageous example, the method comprises receiving user plane payload in dependence on the timing advance configuration of a further apparatus, for example the first radio device.

According to an advantageous example, the validity period indicator and/or the at least one preamble indicator are part of an RRC Release message.

According to an advantageous example, the validity period indicator is associated with an RAN Notification Area, RNA, configuration, in which the validity period is set equal to or is less than a periodic update period of the RNA configuration.

According to an advantageous example, the method comprises determining a mapping of the preamble configuration to an identity of a further apparatus, for example the first radio device.

According to an advantageous example, the determination of the timing advance command comprises determining, via the determined mapping, the identity of the further apparatus in dependence on the dedicated radio resource, the preamble was received.

According to a fifth aspect an apparatus is provided, the apparatus comprising at least: receiving means to receive at least one validity period indicator, which indicates at least one validity period for a timing advance configuration of the apparatus, and at least one preamble indicator, which indicates a preamble configuration; transmitting means to transmit, prior to an end of the validity period, the at least one preamble in dependence on the preamble configuration; receiving means to receive a timing advance command in response to the transmitted preamble; and updating means to update the timing advance configuration of the apparatus in dependence on the received timing advance command.

According to an advantageous example, the preamble configuration comprises at least one of the following: a preamble format; a preamble sequence; at least one dedicated radio resource.

According to an advantageous example, the first device comprises transmitting means to transmit a plurality of preambles via at least a part of a plurality of dedicated radio resources, which are separated in time over at least one validity period.

According to an advantageous example, the first device comprises transmitting means to transmit a plurality of preambles via at least a part of a plurality of dedicated radio resources, which are time contiguous within the at least one validity period.

According to an advantageous example, the first device comprises increasing means to increase a transmission power for the transmission of the respective preamble at least once.

According to an advantageous example, the preamble is contention-free.

According to an advantageous example, the first device comprises transmitting means to transmit user plane payload in dependence on the timing advance configuration of the apparatus.

According to an advantageous example, the validity period indicator and/or the at least one preamble indicator are part of an RRC Release message.

According to an advantageous example, the validity period indicator is associated with an RAN Notification Area, RNA, configuration, in which the validity period is set equal to or is less than a periodic update period of the RNA configuration.

According to a sixth aspect of the description an apparatus, for example a second radio device, of a radio communications network is provided, wherein the apparatus comprises at least: transmitting means to transmit or receiving means to receive at least one validity period indicator, which indicates at least one validity period for a timing advance configuration, and at least one preamble indicator, which indicates a preamble configuration; receiving means to receive at least one preamble in accordance with the preamble configuration; determining means to determine a timing advance command; transmitting means to transmit the determined timing advance command in response to the received preamble.

According to an advantageous example, the preamble configuration comprises at least one of the following: a preamble format; a preamble sequence; at least one dedicated radio resource.

According to an advantageous example, the second device comprises receiving means to receive a plurality of preambles via at least a part of a plurality of dedicated radio resources, which are separated in time over at least one validity period.

According to an advantageous example, the second device comprises receiving means to receive a plurality of preambles via at least a part of a plurality of dedicated radio resources, which are time contiguous within the at least one validity period.

According to an advantageous example, the preamble is contention-free.

According to an advantageous example, the second device comprises receiving means to receive user plane payload in dependence on the timing advance configuration of a further apparatus, for example the first radio device.

According to an advantageous example, the validity period indicator and/or the at least one preamble indicator are part of an RRC Release message.

According to an advantageous example, the validity period indicator is associated with an RAN Notification Area, RNA, configuration, in which the validity period is set equal to or is less than a periodic update period of the RNA configuration.

According to an advantageous example, the second device comprises determining means to determine a mapping of the preamble configuration to an identity of the further apparatus, for example the first radio device.

According to an advantageous example, the determination of the timing advance command comprises determining, via the determined mapping, the identity of the further apparatus, for example the first radio device, in dependence on the dedicated radio resource, the preamble was received.

### BRIEF DESCRIPTION OF THE FIGURES

FIGS. 1 and 2 each depict a schematical sequence diagram;

FIGS. 3 and 4 each depict a schematic radio resource-time diagram; and

FIG. 5 a schematical block diagram of radio devices.

### DESCRIPTION OF THE EMBODIMENTS

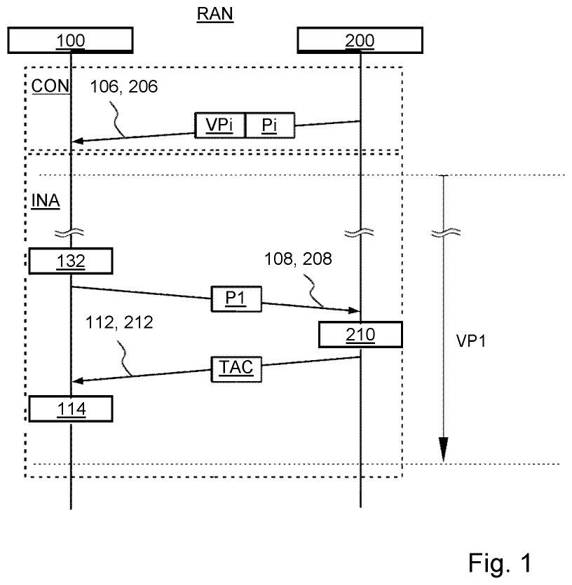

FIG. 1 depicts a schematical sequence diagram. An apparatus, for example a first radio device 100, for example a user equipment UE, of a radio communications network, for example of a radio access network RAN, is configured to receive, via a receiving module or receiving means 106, during an RRC Connected mode CON, at least one validity period indicator VPi, which indicates at least one validity period VP1 for a timing advance configuration of the first radio device 100, and at least one preamble indicator Pi, which indicates a preamble configuration, in particular at least one preamble property and/or a dedicated radio resource in the sense of a transmission opportunity, wherein the preamble is intended for requesting a new timing advance command. A transmission module or transmission means 108 of the first radio device 100 is configured to transmit, during the RRC Inactive mode INA, the at least one preamble P1 prior to an end of the validity period VP1 via a random access channel, for example PRACH.

The first radio device 100 receives a timing advance command TAC. The timing advance command TAC is received, in response to the transmitted preamble P1, via the random access channel, using a receiving module or receiving means 112, during the RRC Inactive mode and prior to the end of the validity period VP1.

An updating module or updating means 114 updates, during the RRC Inactive mode INA, the timing advance configuration, in particular a timing advance value, of the first radio device 100 in dependence on the received timing advance command TAC.

An apparatus, for example a second radio device 200, for example a base station or a next generation NodeB gNB, of the radio communications network, for example of the radio access network RAN comprises a transmission module or transmission means 206, which is configured to transmit 206 or receive, during the RRC Connected mode CON, the at least one validity period indicator VPi, which indicates the at least one validity period VP1 for the timing advance configuration, and the at least one preamble indicator Pi, which indicates the preamble configuration. The preamble configuration is intended to configure the preamble P1, which is intended for requesting the new timing advance command TAC via a transmission of the at least one preamble P1 in accordance with the preamble configuration.

The second radio device 200 comprises a receiving module or receiving means 208 to receive, during the RRC Inactive mode INA, the at least one preamble P1 via the radio resource rr2, which is dedicated to a reception of the preamble P1 from the first device 120 in accordance with the preamble configuration.

The second radio device 200 determines, via a processing module or determining means 210, a timing advance command TAC for the first radio device 100, which is identified via the received preamble P1. The TAC is determined, for example, in dependence on an estimated propagation delay between the first and second device 100, 200.

The second radio device transmits, via a transmission module or transmission means 212, during the RRC Inactive mode INA of the first radio device 100, the determined timing advance command TAC in response to the received preamble P1 via the random access channel.

According to a processing module or determining means 210, the identity of the first radio device 100 is determined in order to determine the corresponding timing advance command TAC for the identified first radio device 100. The TAC is determined by the second radio device 200, for example in dependence on measurements, which are associated with the respective first radio device 100. Therefore, the measurements can be identified via the identity of the first radio device 100, and the TAC is determined in dependence on the identified measurements.

FIG. 2 depicts a sequence diagram. Reference is made to FIG. 1.

The second radio device 200 determines, via a processing module or determining means 202, the preamble configuration and a mapping of the preamble configuration of the preamble P1 to an identity of a first radio device 100. The preamble P1 is determined to be contention-free. The preamble configuration for transmitting at least the preamble P1 comprises at least one of the following: a preamble format; a preamble sequence; at least one dedicated radio resource as at least one transmission opportunities where the second radio device 200 expects to receive requests for a new timing advance command TAC.

The PRACH slots/occasions indicated via the preamble configuration are aligned with the TA timer expiration/the end of the validity period VP1. For example, the second radio node 200 reserves the at least one radio resource for the transmission of the preamble at a point in time, which is arranged before the end of the validity period. Also, a further at least one radio resource is reserved for the transmission of the timing advance command TAC towards the first radio device 100, wherein this further at least one radio resource is determined to end before the end of the validity period VP1.

The plurality of dedicated radio resources rr1, rr2 represent multiple preamble transmission opportunities that are configured to occur with a higher frequency than the at least one validity period VP1.

According to an example, the preamble indicator Pi is transmitted before the validity period indicator VPi via a preamble configuration message in order to assign a certain preamble to the first radio device 100.

According to an example, for UEs with low mobility, the preamble P1 can be configured to be used in a set of adjacent cells in order to reduce the resources within the RNA. This set is updated in dependence on the first radio device activity across time and its movement i.e. the activation of the corresponding random access preamble in the adjacent cells.

The second radio device 200 configures the preambles to a first radio device 100 and thus is aware of the mapping between first radio device and preamble. The preamble configuration includes the time and frequency resources, the radio resource, where these preambles can be transmitted as well as the physical properties of the Zadoff-Chu preambles. In the case of PRACH, these radio resource can be termed PRACH opportunities. Within these PRACH opportunities there are multiple preambles that can be transmitted via the cyclic shift of the Zadoff-Chu root sequences. A single first radio device is able to transmit a PRACH preamble per PRACH opportunity.

According to a processing module or determining means 204 the at least one validity period VP1 is determined. The validity period indicator VPi comprises the determined at least one validity period VP1 or a reference indicating the determined at least one validity period VP1.

The validity period indicator VPi and/or the at least one preamble indicator Pi are part of an RRC Release message RRC_REL, which is transmitted via the transmission module or transmission means 206. The first device 100 enters the RRC Inactive state upon receiving the RRC Release message RRC_REL.

The validity period indicator VPi is associated with or part of a RAN Notification Area, RNA, configuration RNAc, in which the validity period VP1, VP2 is set equal to or is less than a periodic update period of the RNA configuration RNAc. According to an example, the values for the validity period are set per cell in the RNA.

According to another example, the validity period indicator is associated with or part of a Suspend Configuration. The second apparatus 200 moves the first apparatus 100 from RRC_CONNECTED to RRC_INACTIVE by sending an RRC Release message towards the first apparatus 100, the RRC Release message comprising the Suspend Configuration, which comprises a RNA configuration.

According to an example, the preamble indicator Pi is also part of the RAN Notification Area, RNA, configuration RNAc. Therefore, the further second radio device 300, for example in form of a gNB, is aware of preambles received and intended as requests for a new timing advance command.

The radio access preamble P1 or the corresponding preamble indicator Pi is exchanged with the further second radio device 300, wherein the radio devices 200, 300 are operating in a common RAN Notification Area, RNA, and wherein the radio devices 200, 300 operate in the one or different radio cells. The radio access preamble P1 is configured for the first radio device 100 for cases where the first radio device 100 moves from the radio device 200 to the radio device 300 and performs the procedure there. The scheme outlined for the second radio device 200 is also applicable to the further second radio device 300, for example, when the first radio device 100 moves into an area being served by the further second radio device 300.

According to a processing module or processing means 130, the first radio device 100 starts the validity period P1. As long as the validity period is active or running, the timing advance configuration is considered valid by the first radio device 100.

According to a processing module or determining means 132, the first radio device 100 determines that the validity period VP1 is about to end and starts requesting a new TAC by transmitting the preamble P1 towards the second radio device 200. Whenever the first radio device 100 performs a cell reselection, the validity period VP1 is reset at the first radio device 100. According to another example, whenever the first radio device 100 performs a cell reselection to a cell not belonging to the RNA configured for the first radio device 100, the validity period VP1 is reset at the first radio device 100. So, upon a cell reselection and/or upon crossing the RNA, the active validity period VP1 is not being used anymore.

Upon the reception of the preamble P1, the second radio device 200 responds with a random-access response including the TA command TAC. For example, this random-access response is a reduced version of the random-access response, which includes the TA command, and potentially further information associated with the configuration of the UL CG operation in RRC Inactive mode INA.

The determination, via processing module or determining means 210, of the timing advance command TAC comprises determining, via the determined mapping, the identity of the first radio device 100 in dependence on the dedicated radio resource rr2, the preamble P1 was received.

For example, the timing advance command TAC is transmitted over at least one PDSCH resource rrP, which is indicated to a set of first radio devices 100, UEs, via a dedicated DCI scrambled with a RA-RNTI. This set of UEs comprises the UEs that transmitted a PRACH preamble in a specific PRACH opportunity. The RA-RNTI identifies the PRACH opportunity. Before entering an RRC Inactive mode INA, the first device 100 is in the RRC Connected mode CON. In the RRC Connected mode CON, the timing advance is assumed valid since the timing advance is maintained by the second radio device 200 via received timing advance commands. So, when entering the RRC Inactive mode INA, the present state of the timing advance is assumed valid.

The timing advance command TAC is used by the first radio device 100 to adjust the existing timing advance configuration. For example, the timing advance command TAC provided during a first random access procedure is an absolute timing advance, whereas the subsequent timing advance commands TACs, which are submitted during the validity periods VP1, VP2 in the RRC Inactive mode INA, are relative.

The timing alignment update via the processing module or updating means 114 is made in multiples of 16·64·Tc/2μ, where Tc and μ are respectively the basic time unit and the subcarrier spacing configuration. The lower is the subcarrier spacing the higher is the value of the spatial granularity. Taking μ=0, corresponding to the smallest subcarrier spacing of 15 kHz as an example, then the second radio device 200, the gNB, adjusts the timing of the first radio device 100, the UE, if the first radio device 100 moves more than 156 m from the gNB due to the large timing adjustment granularity. Vice-versa, taking μ=4, corresponding to the largest subcarrier spacing of 240 kHz, the first radio device 100 can move less than 10 m from the gNB, before a timing adjustments may be feasible. As there is some flexibility in the first radio device 100 transmit timing due to the cyclic prefix, the first radio device 100 shall move a larger distance before an update of the timing advance value of the timing advance configuration becomes desirable. When the first radio device 100 is un-scheduled for any UL transmissions there is a risk that the UE mobility or changes to the propagation environment will cause the TA to change. For example, the cyclic prefix of the CP-OFDM signal will allow for some drift in transmit timing, but just to a certain extent, as the CP also ensures protection against loss of orthogonality due to multipath propagation in the mobile radio channel. For these reasons, the second radio device 200, the gNB, configures the validity period, which can be termed time alignment timer, which represents a time under which the timing advance configuration, the TA value, is assumed valid. Upon the validity period expiring, the first radio device 100 is no longer allowed to assume synchronization to the second radio device 200 and hence would not be allowed to perform UL transmissions before TA has been properly established again.

In order to enter the second validity period VP2, the first radio device comprises the processing module or processing means 140. According to the processing module or processing means 140, the first radio device 100 starts the second validity period P2. For example, the second validity period VP2 equals the first validity period. In another example, the validity periods differ.

According to the processing module or processing means 140, the first radio device 100 sets the validity status of the updated timing advance configuration to valid and starts running a timer for surveillance of the end of the respective validity period VP1, VP2. This allows the first radio device 100 to use CG-based SDT in the presence of small UL payload. The transmission of the preamble P1 indicates to the second radio device 200 the indication for adjusting the timing advance at the side of the first radio device 100.

The first radio device 100 transmits, via a transmission module or transmission means 150, during the RRC Inactive mode INA of the first radio device 100, user plane payload d in dependence on the currently active timing advance configuration of the first radio device 100. The transmission is done for example, via SDT, Short Data Transmission. SDT, Short Data Transmissions, allows the first radio device 100, which is in RRC Inactive state, to transmit small data portions. For example, for the SDT transmission of the user plane payload d the first radio device 100 uses configured grant-based SDT. For example, pre-configured PUSCH resources are used to transmit the user plane payload.

The second radio device 200 receives, via a receiving module or receiving means 250, user plane payload d in dependence on the timing advance configuration of the first radio device 100. The provided scheme maintains upload opportunities for transmitting small data packets during the whole RRC Inactive state, as long as the timing advance configuration is considered valid.

For the SDT transmission of user plane payload d the first radio device 100 can either encapsulate the payload in RRC messages Msg3 of the random access procedure or use pre-configured PUSCH resources, as in 2-step Random Access based SDT or Configured gran-based SDT.

In another example, SDT can also be implemented with 4-step RACH where the Msg3, the scheduled transmission, includes the user plane payload d. The substantially same observation is applicable to 2-step RACH. In order to enable this, the RRC configuration either during the first radio device transition from RRC Connected mode CON to RRC Inactive mode INA or via the periodic transmitted SIBs by the network is configured in order to identify specific sets of PRACH preambles either 2-step or 4-step RACH which are dedicated to SDT transmission.

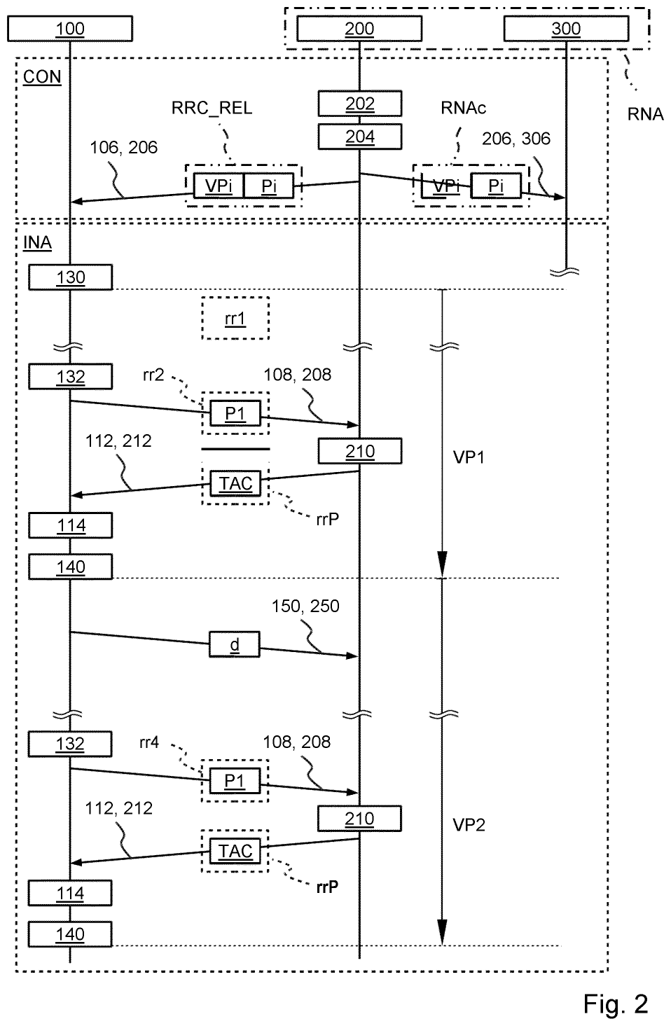

FIGS. 3 and 4 illustrate a respective preamble configuration, in particular that multiple CF RACH preambles are configured across multiple RACH opportunities different in time, that allow the first radio device to perform the described TA keep-alive procedure during the RRC Inactive mode.

FIG. 3 depicts an example of the transmission module or transmission means 108/the reception module or receiving means 108 configured to transmit/receive a plurality of preambles P1 via at least a part of a plurality of dedicated radio resources rr1, rr2, rr3 on the one hand and a further plurality of radio resources rr4, rr5, rr6 on the other hand, which are separated in time over the at least one validity period VP1 and VP2, respectively.

FIG. 4 depicts an example of the transmission module or transmission means 108/the reception module or receiving means 108 configured to transmit/receive a plurality of preambles P1 via at least a part of a plurality of dedicated radio resources rrA, rrB, rrC; rrD, rrE, rrF, which are time contiguous within the at least one validity period VP1, VP2.

The first radio device 100 of FIG. 1 or 2 transmits preambles while simultaneously increasing a transmission power for the transmission of the respective preamble Pl. The second radio device 200 of FIG. 1 or 2 receives, via a receiving module or receiving means 208, a plurality of preambles P1 via at least a part of a plurality of dedicated radio resources rrA, rrB, rrC and rrD, rrE, rrF, which are time contiguous within the validity period VP1, VP2, respectively.

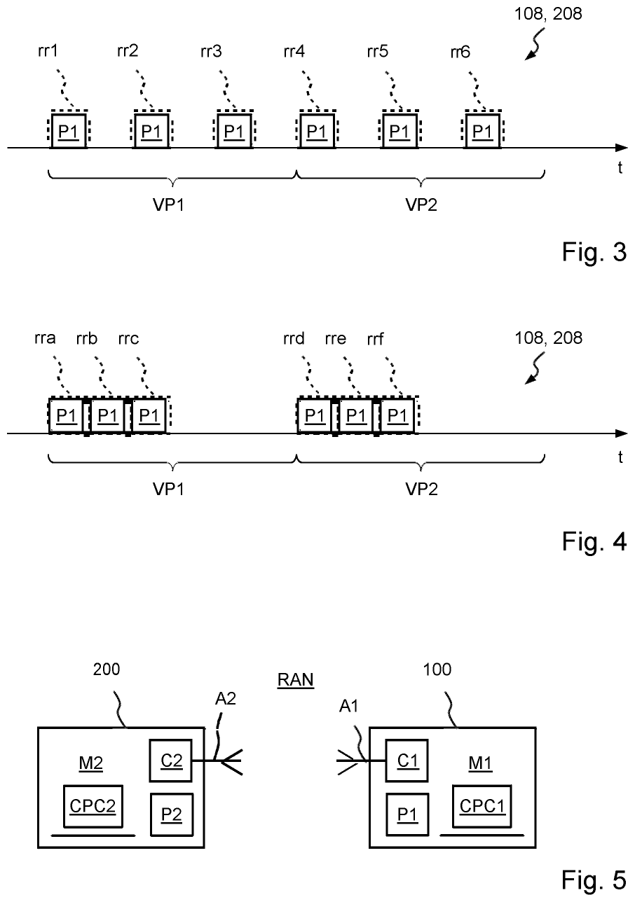

FIG. 5 schematically depicts the radio access network RAN. The first radio device 100 comprises at least one processor P1, at least one memory M1 including computer program code CPC1, and at least one communication module C1 that is coupled with at least one antenna A1. The at least one memory M1 and computer program code CPC1 are configured, with the at least one processor P1, and the at least one communication module or communication means C1, to cause the first radio device 100 at least to operate according to the present description. The second radio device 200 comprises at least one processor P2, at least one memory M2 including computer program code CPC2, and at least one communication module or communication means C2 that is coupled with at least one antenna A2. The at least one memory M2 and computer program code CPC2 are configured, with the at least one processor P2, and the at least one communication module C2, to cause the second radio device 200 at least to operate according to the present description. The first radio device 100 transmits signals in an uplink direction to the second radio device 200. The second radio device 200 transmits signals in a direction to the first radio device 100.

Certain abbreviations that may be found in the description and/or in the figures are herewith defined as follows:
CG Configured Grant
CP Cyclic Prefix
CP-OFDM CP-Orthogonal Frequency-Division
Multiplexing
DCI Downlink Control Information
DL Downlink
gNb Next Generation eNodeB
PRACH Physical Random Access Channel
PUSCH Physical Uplink Shared Channel
RA-RNTI Random Access RNTI
RACH Random Access Channel
RAN Radio Access Network
RNA Radio access network Notification Area
RNTI Radio Network Temporary Identifier
RRC Radio Resource Control
SDT Short Data Transmission
TA Timing Advance
TAC Timing Advance Command
UE User Equipment
UL Uplink

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1-72. (canceled)

73. An apparatus (100) comprising at least one processor, at least one memory including computer program code, and at least one communication module, the at least one memory and computer program code configured, with the at least one processor, and the at least one communication module, to cause the apparatus (100) at least to:
receive (106) at least one validity period indicator (VPi), which indicates at least one validity period (VP1; VP2) for a timing advance configuration of the apparatus (100), and at least one preamble indicator (Pi), which indicates a preamble configuration;
transmit (108), prior to an end of the validity period (VP1; VP2), at least one preamble (P1) in dependence on the preamble configuration; and
receive (112) a timing advance indicator in response to the transmitted preamble (P1).

74. The apparatus (100) according to claim 73 being further configured to:
update (114) the timing advance configuration of the apparatus (100) in dependence on the received timing advance indicator.

75. The apparatus (100) according to claim 73, wherein the timing advance indicator is a timing advance command (TAC).

76. The apparatus (100) according to claim 73, wherein the configuration of the preamble (P1) comprises at least one of the following:
a preamble format;
a preamble sequence;
at least one dedicated radio resource.

77. The apparatus (100) according to claim 73 being further configured to:
transmit (108) the at least one preamble (P1) via a dedicated radio resource (rr1; rr2; rr3; rr4; rr5; rr6).

78. An apparatus (200; 300) comprising at least one processor, at least one memory including computer program code, and at least one communication module, the at least one memory and computer program code configured, with the at least one processor, and the at least one communication module, to cause the apparatus (200; 300) at least to:
transmit (206) or receive (306) at least one validity period indicator (VPi), which indicates at least one validity period (VP1; VP2) for a timing advance configuration, and at least one preamble indicator (Pi), which indicates a preamble configuration;
receive (208) at least one preamble (P1) in accordance with the preamble configuration;
determine (210) a timing advance indicator;
transmit (212) the determined timing advance indicator in response to the received preamble (P1).

79. The apparatus (200, 300) according to claim 78, wherein the timing advance indicator is a timing advance command (TAC).

80. The apparatus (200, 300) according to claim 78, wherein the configuration of the preamble (P1) comprises at least one of the following:
a preamble format;
a preamble sequence;
at least one dedicated radio resource.

81. The apparatus (200, 300) according to claim 78 being further configured to:
determine (202) a mapping of the configuration of the preamble (P1) to an identity of a further apparatus (100).

82. The apparatus (200, 300) according to claim 81, wherein the determination (120) of the timing advance command (TAC) comprises determining, via the determined mapping, the identity of the further apparatus (100) in dependence on the dedicated radio resource (rr2), the preamble (P1) was received.

83. A method comprising at least:
receiving (106) at least one validity period indicator (VPi), which indicates at least one validity period (VP1; VP2) for a timing advance configuration of the apparatus (100), and at least one preamble indicator (Pi), which indicates a preamble configuration;
transmitting (108), prior to an end of the validity period (VP1; VP2), at least one preamble (P1) in dependence on the preamble configuration; and
receiving (112) a timing advance indicator in response to the transmitted preamble (P1).

84. The method according to claim 83 comprising:
updating (114) the timing advance configuration of the apparatus (100) in dependence on the received timing advance indicator.

85. The method according to claim 83, wherein the timing advance indicator is a timing advance command (TAC).

86. The method according to claim 83, wherein the configuration of the preamble (P1) comprises at least one of the following:
a preamble format;
a preamble sequence;
at least one dedicated radio resource.

87. The method according to claim 83 comprising
transmitting (108) the at least one preamble (P1) via a dedicated radio resource (rr1; rr2; rr3; rr4; rr5; rr6).

88. A method comprising at least:
transmitting (206) or receiving (306) at least one validity period indicator (VPi), which indicates at least one validity period (VP1; VP2) for a timing advance configuration, and at least one preamble indicator (Pi), which indicates a preamble configuration;
receiving (208) the at least one preamble (P1) in accordance with the preamble configuration;
determining (210) a timing advance indicator; and
transmitting (212) the determined timing advance indicator in response to the received preamble (P1).

89. The method according to claim 88, wherein the timing advance indicator is a timing advance command (TAC).

90. The method according to claim 88, wherein the configuration of the preamble (P1) comprises at least one of the following:
a preamble format;
a preamble sequence;
at least one dedicated radio resource.

91. The method according to claim 88 further comprising:
determining (202) a mapping of the configuration of the preamble (P1) to an identity of a further apparatus (100).

92. The method according to claim 91, wherein the determination (120) of the timing advance command (TAC) comprises determining, via the determined mapping, the identity of the apparatus (100) in dependence on the dedicated radio resource (rr2), the preamble (P1) was received.
